(19) United States
(12) Patent Application Publication
(10) Pub. No.: US 2016/0048100 A1
(43) Pub. Date: Feb. 18, 2016

(54) DEVICE TO INSERT WEB-SHAPED RECORDING MEDIA INTO THE TRANSPORT PATH OF PRINTERS

(71) Applicant: Oce Printing Systems GmbH & Co. KG, Poing (DE)

(72) Inventors: Andreas Hempel, Moosburg (DE); Alexander Kreiter, Woerth (DE)

(73) Assignee: OCE PRINTING SYSTEMS GMBH & CO. KG, Poing (DE)

(21) Appl. No.: 14/824,444

(22) Filed: Aug. 12, 2015

(30) Foreign Application Priority Data
Aug. 12, 2014 (DE) 102014111462.0

(51) Int. Cl. G03G 15/00

(52) U.S. Cl. CPC G03G 15/6517

(57) ABSTRACT

In a device or method for insertion of a recording medium into a transport path of a printer an elastic insertion plate is provided that, at an end facing away from a transport direction of the transport path, has a clamper to accept the recording medium to be inserted as well as at least one transport surface for interaction with at least one transport roller. The clamper comprises a magnet and an associated metal surface that accepts a leading end of the recording medium between the magnet and the metal surface such that the recording medium leading end is releasably clamped.

### BACKGROUND OF THE INVENTION

The disclosure concerns a device and a method to insert web-shaped recording media into the transport path of printers.

Electrographic printers that operate with toner or liquid developer for single-sided or double-sided printing of web-shaped recording media are generally known. Corresponding to the color spectrum that is used, they include a plurality of individual print groups with a downstream fixer station.

One problem with such printers is the insertion or threading of web-shaped recording media through the printer before the actual start of printing. Web-shaped recording media—for example made of paper rolls of differing paper thickness—may thereby be slightly damaged.

A device for the insertion of continuous recording media into electrographic printing or copying devices is known from DE-19801317 C1. The device has a tensioner at each side of the transport path of the recording medium, as well as a grabber bar running transverse to the transport path to accept the leading edge of the recording medium. For insertion, the recording medium is drawn over the grabber bar by the printer with the aid of the lateral tensioner.

### SUMMARY

It is an object to provide an inserter of web-shaped recording media, which inserter has a design that is simple and not prone to malfunction and that enables recording media made of differing materials to be securely inserted.

In a device or method for insertion of a recording medium into a transport path of a printer an elastic insertion plate is provided that, at an end facing away from a transport direction of the transport path, has a clamper to accept the recording medium to be inserted as well as at least one transport friction surface for interaction with at least one transport roller. The clamper comprises a magnet and an associated metal surface that accepts a leading end of the recording medium between the magnet and the metal surface such that the recording medium leading end is releasably clamped.

### BRIEF DESCRIPTION OF THE DRAWINGS

FIG. 1 is a schematic depiction of an elastic insertion plate with an associated damper;

FIG. 2 is a schematic depiction of the elastic insertion plate with a recording medium attached thereto;

FIG. 3 is a schematically depicted printer system with two printer stations and a correspondingly designed transport path; and

FIG. 4 is a fragmentary perspective view of the elastic insertion plate with associated clamper clamped to an end of the recording medium.

### DESCRIPTION OF EXEMPLARY EMBODIMENTS

For the purposes of promoting an understanding of the principles of the invention, reference will now be made to preferred exemplary embodiments/best mode illustrated in the drawings and specific language will be used to describe the same. It will nevertheless be understood that no limitation of the scope of the invention is thereby intended, and such alterations and further modifications in the illustrated embodiments and such further applications of the principles of the invention as illustrated as would normally occur to one skilled in the art to which the invention relates are included herein.

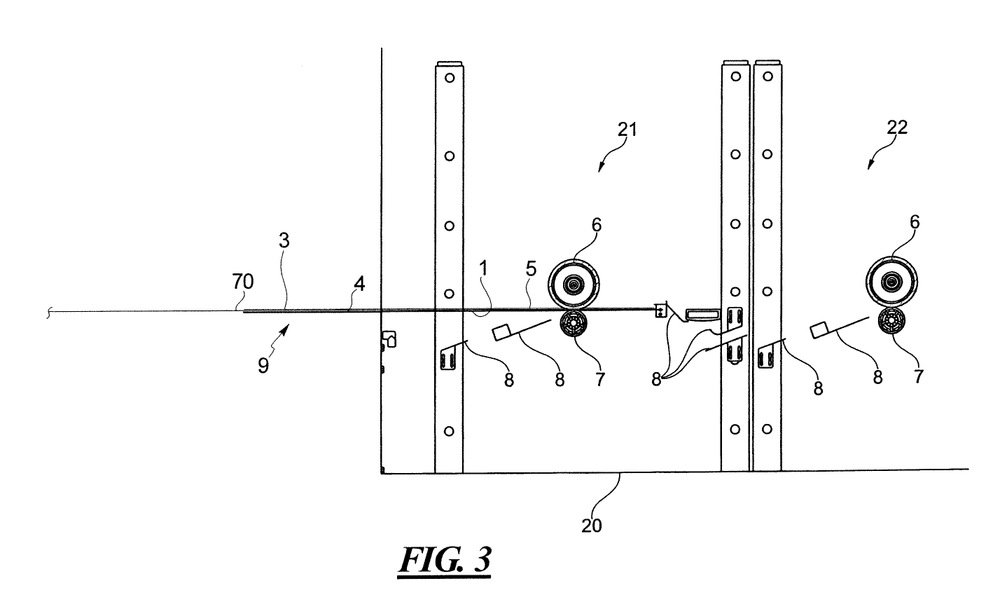

Given the device according to the exemplary embodiment, the recording medium (which is preferably comprised of paper) is moved through a printer 20 (see FIG. 3) with the aid of an elastic insertion plate system 9. Therefore, there is no need for a special intake mechanism in the transport path of the printer 20.

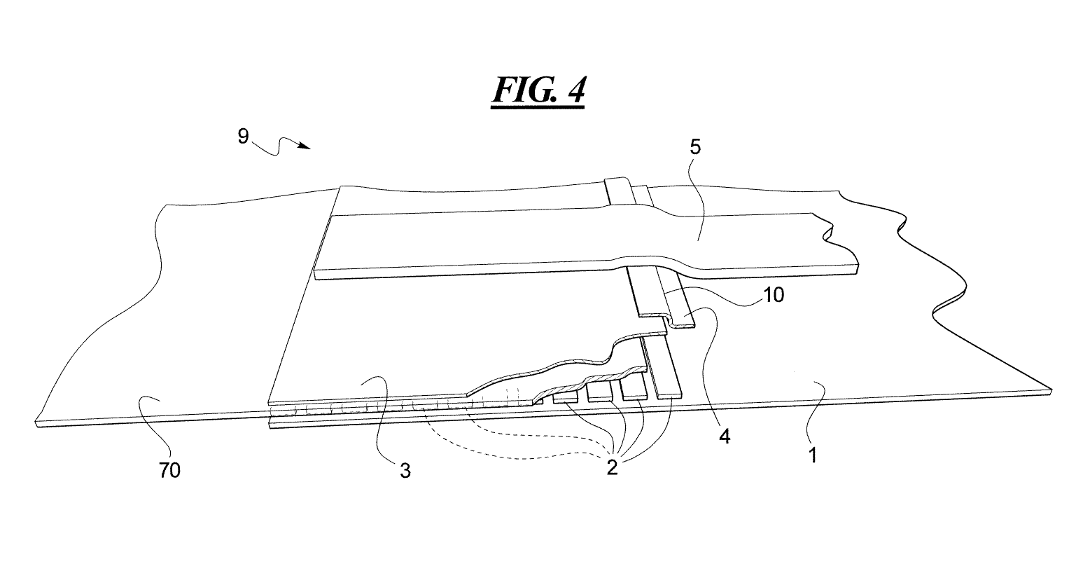

In order to be able to insert a leading end of a continuous paper 70 simply and securely into a printing path, the insertion plate system 9 (shown in FIGS. 1, 2 and 4) is provided. It is comprised of an elastic carbon (or plastic) plate 1 with a clamper arranged thereupon to accept the leading end of the recording medium 70. In order to connect the leading end of the roller paper with the insertion plate so that it may be released, the system 9 comprises metal strips 2 arranged on the carbon plate 1 as well as a magnetic film 3 that may be folded down (and shown partially cut-away in FIG. 1 to show the strips 2), which magnetic film 3 is attached to the carbon plate 1 via an adhesive hinge 4 having a bend 10.

Silicone foam strips 5 extending over the length of the carbon plate 1 serve as the friction surfaces 2 upon transport of the carbon plate through the transport channel of the printer system.

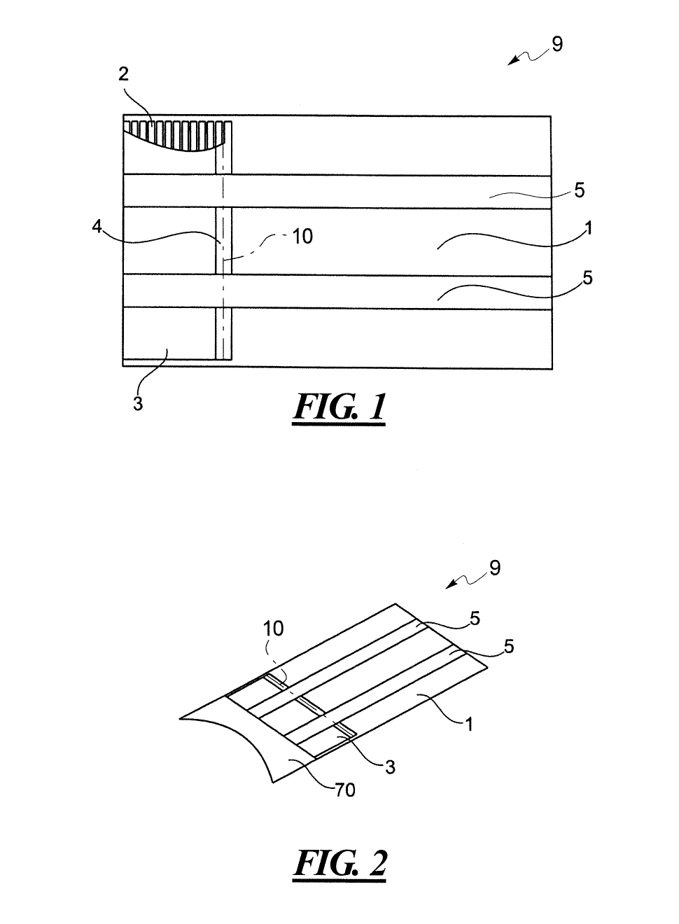

Corresponding to the depiction of FIG. 2, for this the leading end of the roller paper 70 is pinched between magnetic film 3 and metal strips 2 and then is drawn, together with the carbon plate 1, through the printer system.

Corresponding to FIG. 3, the transport of the insertion plate 1 of insertion plate system 9 together with pinched paper 70 takes place via the transport printer systems in the individual print groups 21 or 22 of a printer 20 and that respectively have a transfer roller 6 with associated contact pressure roller 7.

Furthermore, guides 8 in the form of baffle plates are arranged in the transport channel, which baffle plates serve to guide the insertion plate upon threading through the printer 20. The plate length of the insertion plate 1 is thereby to be dimensioned so that the plate, together with the paper 70, may be drawn through the individual print groups 21, 22. For this, it has a length that is greater than the clearance between two most closely adjacent transport rollers 6, 7 of the individual print groups 21, 22.

Although preferred exemplary embodiments are shown and described in detail in the drawings and in the preceding specification, they should be viewed as purely exemplary and not as limiting the invention. It is noted that only preferred exemplary embodiments are shown and described, and all variations and modifications that presently or in the future lie within the protective scope of the invention should be protected.

We claim as our invention:

1. A device for insertion of a recording medium formed as a web into a transport path of a printer, comprising:
an elastic insertion plate that, at an end facing away from a transport direction of the transport path, has a clamper connected to the plate to accept the recording medium to be inserted as well as at least one transport friction surface arranged on the insertion plate for interaction with at least one transport roller arranged in the transport path; and
the clamper comprising a magnet and an associated at least one metal surface and that accepts a leading end of said recording medium between the magnet and the metal surface such that the recording medium leading end is releasably clamped.

2. The device according to claim 1 wherein the device is designed for transport through multiple individual print groups of the printer that are arranged in series and respectively have transport rollers, a plate length of the insertion plate being greater than a clearance between two closest transport rollers of adjacent print groups such that the plate together with the recording medium are transported from one print group to the print group which is adjacent.

3. The device according to claim 2 wherein guide elements are arranged on both sides outside of the transport path for the recording medium to guide the insertion plate at least between the print groups.

4. The device according to claim 1 wherein the insertion plate is designed from plastic.

5. The device according to claim 1 wherein the insertion plate comprises a carbon plate.

6. The device of claim 1 wherein the printer has multiple colors of liquid developer.

7. The device of claim 1 wherein the printer is for the printing of recording media of differing thickness.

8. The device of claim 1 wherein the clamper magnet comprises a magnetic foil connected to one end of a hinge, another end of the hinge being connected at said end of said elastic insertion plate.

9. The device of claim 1 wherein a plurality of said metal strips are provided arranged on a surface of said elastic insertion plate at said end and positioned opposite said magnet.

10. The device of claim 1 wherein said magnet comprises a magnetic foil connecting by a flexible hinge to said elastic insertion plate at said end and a plurality of said metal surfaces are provided arranged on said elastic insertion plate at said end such that they lie opposite said magnetic foil when said leading end of said recording medium is clamped between said magnetic foil and said of plurality metal surfaces.

11. The device of claim 1 wherein a plurality of said transport friction surfaces are provided each comprising a strip arranged on top of said magnet and also on a top surface of said elastic insertion plate.

12. The device of claim 11 wherein said strip comprises a foam strip.

13. A device for insertion of a recording medium formed as a web into a transport path of a printer, comprising:
an elastic insertion plate that, at an end facing away from a transport direction of the transport path, has a damper connected to the plate to accept the recording medium to be inserted; and
the clamper comprising a magnet and an associated at least one metal surface and that accepts a leading end of said recording medium between the magnet and the metal surface such that the recording medium leading end is releasably clamped.

14. A method for insertion of a recording medium web into a transport path of a printer, comprising the steps of:
providing an elastic insertion plate that, at an end facing away from a transport direction of the transport path, has a clamper connected to the plate to accept the recording medium to be inserted, the clamper comprising a magnet and an associated at least one metal surface and that accepts a leading end of said recording medium leading end between the magnet and the metal surface such that the recording medium is releasably clamped;
inserting leading end of the recording medium between the magnet and the least one associated metal surface and then clamping the leading end; and
feeding a leading end of said elastic insertion plate into the transport path of the printer.

15. The method of claim 14 wherein the magnet comprises a magnetic foil connected to a flexible hinge, and with the magnetic foil pivoted away from the at least one metal surface placing said leading end of said recording medium onto said metal surface and then moving the magnetic foil down towards said metal surface to clamp the leading end of the recording medium between the magnetic foil and the metal surface.
